(19) United States
(12) Patent Application Publication
(10) Pub. No.: US 2019/0360620 A1
(43) Pub. Date: Nov. 28, 2019

(54) BELL AND SPIGOT CONNECTION AND COMPOSITE GASKET SEAT SPIGOT RING FOR MAINLINE PIPES

(71) Applicant: AP INFRASTRUCTURE SOLUTIONS LP, Concord (CA)

(72) Inventors: Randy McDonald, Guelph (CA); Nedal Mohamed, Guelph (CA); Phil Green, Woodstock (CA); Rob Julien, Barrie (CA); Bill Bengough, London (CA)

(21) Appl. No.: 16/204,331

(22) Filed: Nov. 29, 2018

Related U.S. Application Data
(60) Provisional application No. 62/592,520, filed on Nov. 30, 2017.

(51) Int. Cl. F16L 21/035

(52) U.S. Cl. CPC F16L 21/035

(57) ABSTRACT

A bell and spigot connection and composite gasket seat spigot ring provides seal mainline pipes (e.g. HDPE and SRPE pipes). An upper (HDPE) spigot sleeve defines an annular groove to provide a gasket seat and is welded to a lower (HDPE) sleeve. A metal ring is received in a ring cavity defined between the sleeves. The metal ring has a height that is a substantial proportion of its width, (e.g. 50% or more). A stepped spigot surface receives a liner surface at a pipe end for welding. A bell is formed on a first pipe segment from a second pipe segment having a same construction where the second segment is larger in diameter so that an exterior surface (e.g. a top of a helically wound rib or top of annularly spaced spacer blocks) of the first segment may be welded to an interior surface (pipe liner) of the second segment.

### CROSS-REFERENCE TO RELATED APPLICATION

The present application claims, in respect of the United States, the domestic benefit of, and in respect of Canada, Pairs Convention priority to U.S. Provisional Patent Application No. 62/592,520, filed Nov. 30, 2017 and entitled “Bell and Spigot Connection and Composite Gasket Seat Spigot Ring for SRPE Pipes”, the entire contents of which is incorporated herein in respect of the United States only.

### FIELD OF THE INVENTION

The present disclosure relates to mainline pipes for drainage applications including high density polyethylene (HDPE) pipes and steel reinforced (high density) polyethylene (SRPE) pipes and bell and spigot connectors therefor.

### BACKGROUND OF THE INVENTION

Gravity flow mainline pipes are commonly used for various drainage and other water transport applications (e.g. including storm and sanitary sewage, irrigation, reline and water storage, etc.) Often they are constructed of HDPE or SRPE and may have a smooth outer surface or one with ridges.

SRPE pipes may provide needed rigidity for certain installations, particularly gravity flow subterranean or partially subterranean installations such as storm sewers, sanitary sewers, culverts, pipe rehabilitation and highway drainage. SRPE pipes have wound ribs, which ribs are usually helically wound rather than annularly about the pipe. The ribs may have an omega (Ω) shape or other cross-sectional shape. The ribs are often of galvanized steel and are totally encapsulated with polyethylene. The pipe has a smooth (e.g. HDPE) liner.

A length of two or more pipes may be connected end to end in a sealing engagement. Bell and spigot type connections for gravity flow pipes are known and used in such installations. One example is the Duromaxx™ product by Contech Engineered Solutions LLC, West Chester Ohio, USA.

It is desired to provide a bell and spigot type connection (and individual components thereof) for a gravity flow pipe including pipe having helically wound ribs (including omega shaped ribs).

### SUMMARY OF THE INVENTION

Disclosed is a bell and spigot connection and composite gasket seat spigot ring such as for gravity flow pipes including for HDPE and SRPE pipes. A spigot ring comprises an upper sleeve defining an annular groove to provide a gasket seat; a lower sleeve welded to the upper sleeve; and a metal ring received in a ring cavity defined between the sleeves. The sleeves comprise HDPE and each spigot ring component may be extruded and rolled to define the annular shape. A stepped spigot surface may receive a liner surface at a pipe end for welding. Mating external surfaces of the sleeves may provide weld seats for welding the sleeves to one another. A bell is formed on a first pipe segment from a second pipe segment having a same construction but where the second segment is larger in diameter so that an exterior surface of the first segment may be attached to an interior surface of the second segment such as by welding. In an SRPE pipe, the exterior surface may be attached such as by welding a top of a helically wound rib in the first segment to a liner of the second segment. In an HDPE pipe, intermediate HDPE spacer blocks or wedges may be welded in a spaced configuration about the exterior surface of the first surface and, once the second segment is in place, to the interior surface of the second segment.

There is provided a gasket seat spigot ring comprising: an upper sleeve defining an annular groove on an exterior surface to provide a gasket seat; a lower sleeve welded to the upper sleeve; and a metal ring; wherein the metal ring is received in a ring cavity defined between the upper sleeve and the lower sleeve.

In some applications, the upper sleeve and lower sleeve may each define an annular shape with opposite ends of the upper sleeve welded together and opposite ends of the lower sleeve welded together. In some applications, the lower sleeve may define a stepped pipe receiving surface at a pipe facing edge of an exterior surface opposite the upper sleeve to receive a pipe surface for welding thereto.

In some applications, the spigot ring may be configured to extend substantially equivalent to a height of a rib projecting from a SRPE pipe when the spigot ring is attached to the pipe at the pipe receiving surface.

In some applications, each of the upper sleeve and lower sleeve have respective mating surfaces about their respective peripheries, the mating surfaces each defining weld seats to weld the sleeves to one another.

In some applications, the upper sleeve and lower sleeve comprise HDPE material, preferably formed via extrusion methods where applicable and preferably rolled where applicable to define annular shapes.

In some applications, the metal ring is aluminum or other metal, preferably formed via extrusion methods and preferably rolled to define an annular shape for fitting in the upper sleeve and lower sleeve.

In some applications, the spigot ring comprises one or more walled cavities to provide integrity to the annular groove.

There is disclosed a SRPE pipe comprising a pipe end attached to a spigot ring according to any of the spigot ring teachings herein.

There is provided a method of manufacturing a gasket seat spigot ring comprising: extruding an upper sleeve having a groove to receive a gasket seat on an exterior surface; extruding a lower sleeve, the upper sleeve and lower sleeve defining a ring cavity to receive a metal ring; forming the metal ring; rolling the upper sleeve, lower sleeve and metal rings to define annular shapes; placing the metal ring in the ring cavity between the upper sleeve and lower sleeve; and welding the upper sleeve and lower sleeve together.

There is provided a method of fitting a spigot ring to an end of an SRPE pipe comprising: preparing an exterior surface of an end of the SRPE pipe to receive the spigot ring; guiding the spigot ring partially over the exterior surface; and welding the spigot ring to the end of the SRPE pipe; and wherein, the spigot ring is defined in accordance with any of the teachings provide herein.

In some applications, the spigot ring receives the exterior surface to define a step between a bottom of the spigot ring and an inside diameter of a pipe liner of the pipe for welding. In some applications, a continuous weld is performed around a pipe periphery, inside and outside, where the spigot ring meets the end of the SRPE pipe.

In some applications, preparing comprises removing a portion of a rib of the pipe.

In some applications, preparing comprises machining the pipe to produce a uniform pipe end thickness for welding.

There is provided a mainline pipe and bell assembly comprising: a first SRPE pipe segment defining a mainline pipe and a second SRPE pipe segment defining a bell where each SRPE pipe segment comprises respectively, a pipe liner, a steel rib helically wound about the pipe liner and a top layer over the rib and liner; wherein: the second SRPE pipe segment has an interior diameter sufficiently larger than an outer diameter of the first SRPE pipe segment to receive the first SRPE pipe segment for attachment; an end of the first SRPE pipe segment is inserted into the second SRPE pipe segment partway therethrough; and the pipe liner of the second SRPE pipe segment is attached to the top layer along the rib of the first SRPE pipe segment.

In some applications, each respective liner and top layer comprises HDPE and are attached by welding.

In some applications, the first pipe segment comprises an annular component at the end defining a bell stop, the annular component providing a flange for welding to the pipe liner of the second SRPE pipe segment.

In some applications, the first segment is inserted to about a length of the second segment defined by a measure of 2 times the pitch between rib centers of the helically wound rib of the second segment. In some applications, rib centers of the helically wound rib of the first segment located in the bell are between the rib centers of the helically wound rib of the second segment.

In some applications, the second segment comprises an annular component at an open end thereof to define a bell lip to receive a connecting pipe.

There is provided a method to manufacture a mainline SRPE pipe and bell assembly, the mainline SRPE pipe comprising a pipe liner, a steel rib helically wound about the liner and a top layer over the rib and liner, the method comprising: providing a length of a second SRPE pipe having a same construction as the mainline SRPE pipe to define a bell, the second SRPE pipe having an interior diameter sufficiently larger than an outer diameter of the mainline SRPE pipe for attachment; relatively sliding the mainline SRPE pipe and second SRPE pipe such that the mainline SRPE pipe is partially inserted into the second SRPE pipe defining the bell; and welding the pipe liner of the second SRPE pipe to the top layer, along the rib, of the mainline SRPE pipe.

In some applications, the mainline SRPE pipe comprises an annular bell stop atop the pipe liner at an end of the mainline SRPE pipe. In some applications, the welding welds the pipe liner of the second SRPE pipe to the top layer along the bell stop.

In some applications, the mainline SRPE pipe is inserted into the second SRPE pipe to about a length defined by a measure of 2 times the pitch between rib centers of the second SRPE pipe.

In some applications, rib centers of the steel rib of the mainline SRPE pipe located in the bell are between the rib centers of the second SRPE pipe.

In some applications, the second SRPE pipe comprises an annular component at an open end thereof to define a bell lip to receive a connecting pipe.

The method may further comprising coupling the mainline SRPE pipe and bell assembly to a connecting SRPE pipe having a gasket seat spigot ring fitted to a connecting SRPE pipe end of the connecting SRPE pipe. The gasket seat spigot ring may be as described herein. The method may comprise welding together the pipe liner of the bell and the top layer, along the rib, of the connecting SRPE pipe.

There is provided a method to manufacture a mainline HDPE pipe and bell assembly, the method comprising: welding together an outer surface of the mainline HDPE pipe and a plurality of spacer blocks annularly spaced adjacent a pipe end to receive a bell; providing a length of a second HDPE pipe having a same construction as the mainline HDPE pipe to define the bell, the second HDPE pipe having an interior diameter sufficiently larger than an outer diameter of the mainline HDPE pipe and the plurality of spacer blocks for attachment; relatively sliding the mainline HDPE pipe and second HDPE pipe such that the mainline HDPE pipe with the plurality of spacer blocks is partially inserted into the second HDPE pipe defining the bell; and welding together the second HDPE pipe and the plurality of spacer blocks of the mainline HDPE pipe.

The mainline HDPE pipe may comprise an annular bell stop at an end of the mainline HDPE pipe. The welding may weld the second HDPE pipe to a top of the bell stop and the top define a flange.

The second HDPE pipe may comprises an annular component at an open end thereof to define a bell lip to receive a connecting pipe.

The method may further comprise coupling the mainline HDPE pipe with a bell to a connecting HDPE pipe having a gasket seat spigot ring fitted to a connecting HDPE pipe end of the connecting HDPE pipe. The gasket seat spigot ring may be defined as described herein. The connecting HDPE pipe may comprise a second plurality of spacer blocks annularly spaced adjacent the connecting HDPE pipe end to receive the bell; and the method may comprise welding together the bell and the second plurality of spacer blocks.

These and other aspects will be apparent to those of ordinary skill in the art from a reading of this application.

### BRIEF DESCRIPTION OF THE DRAWINGS

FIG. 1 illustrates a schematic of a profile of a SRPE pipe wall in accordance with one application according to the prior art.

FIG. 2 is a profile of a pre-end to end joint of a first or connecting pipe having a spigot and a second or mainline pipe having a bell, in accordance with an example.

FIG. 3 shows an end to end joint with the first and second pipe cut away in profile and the bell shown not cut away, in accordance with an example.

FIG. 4 is an enlarged view of a second pipe showing a spigot profile in more detail.

FIG. 5 is an enlarged view of a portion of an end of the second pipe of FIG. 4 without the gasket seat.

FIGS. 6A-6B, 7A-7B, 8A-8B, and 9A-9B show respective cross-sectional views, in exploded and assembled forms, of example spigot gasket seats.

FIGS. 10A-10E show an assembly procedure to mount and weld a spigot gasket seat according to FIG. 7B to an end of an SPRE pipe of FIG. 1.

FIG. 11 shows an end view of a mounted spigot gasket seat on an SPRE pipe.

FIG. 12 is a profile of a pre-end to end joint of a first or connecting pipe having a spigot and a second or mainline pipe having a bell, in accordance with an example, where the mainline pipe and connecting pipe have smooth inner and outer surfaces adjacent ends to be joined.

FIG. 13 shows a gasket seat spigot ring having an extension member.

Like references are used for the same features among the separate figures.

### DETAILED DESCRIPTION OF EMBODIMENTS OF THE INVENTION

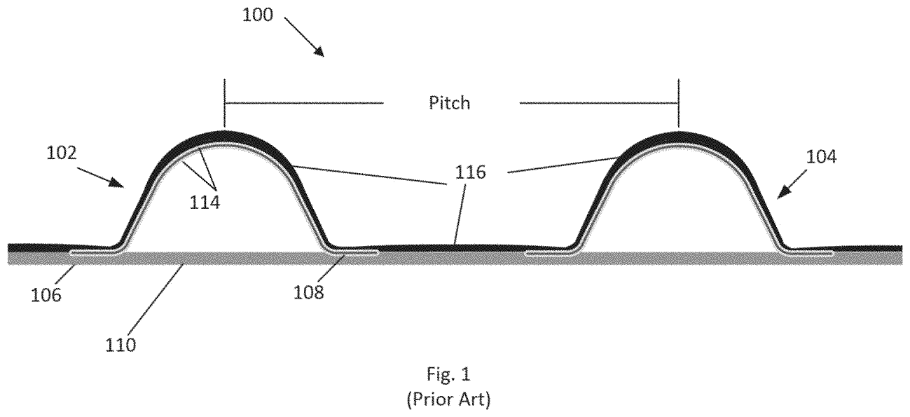

FIG. 1 illustrates a schematic profile of a SRPE pipe wall 100 in accordance with one application according to the prior art. FIG. 1 shows two ribs 102 and 104 of galvanized steel each having an omega-like Ω shape. Ends of the ribs (e.g. 106 and 108 of rib 102) meet the smooth HDPE pipe liner 110. Each rib is encapsulated (top and bottom) with HDPE (e.g. 114). Typically the ribs are encapsulated with a bonding agent first. The exterior (soil side) of the rib is encapsulated with a layer of HDPE during the pipe making process. The HDPE encapsulation of the interior side of the rib is limited to the area of contact of the horizontal feet of the rib with the interior HDPE liner.

The encapsulated ribs and pipe liner 110 are covered with a top layer of HDPE 116. The distance between two adjacent rib center lines is the pitch. It will be understood that in a helical wound SRPE pipe the ribbing is actually a single continuous rib. However, for purposes of this disclosure, each turn around the outer pipe diameter may be considered a separate rib, at least notionally.

SRPE pipe may be designed and manufactured to be conforming to CSA or ASTM or other standards specifications. Some specifications include Canadian Standards Association (CSA) CSA 182.14 and CSA 182.15. In the US, omega shaped and rectangular shaped ribs for SPRE pipe may be governed by American Society for Testing and Materials (ASTM) standard F2435. ASTM F2563 and American Association of State Highway and Transportation Officials (AASHTO) standard MP20 may also apply to applicable SRPE pipe. SRPE pipes in general are gravity flow pipes (as opposed to pressure pipe).

When manufactured in a machine the pipe exits the machine with either square cut ends (plain cut ends) or helical ends. In either case, to connect (join) two pieces of pipe together end to end in order to create a continuous (sealed) pipeline involves an extra process.

The preferred jointing system in the industry is the bell and gasketed spigot system. In this method a length of pipe will have one enlarged end (the bell or the female end) and one spigot end (the male end). In order to make a connection, the spigot of one pipe has to be inserted in the bell of another pipe. The spigot end has to be dressed with a rubber gasket in order to achieve the required seal or water tightness as specified in the standards (specifically CSA B182.15—see clause 6.2).

In accordance with applications described herein there is disclosed a bell and spigot jointing system for mainline pipes having a wall profile such as wall 100 or similar profiles. Manufacturing of bells and spigots is an extra process (i.e. after the length of pipe is constructed) that is carried out on a plain end pipe (square end) after it comes out of the pipe manufacturing machine (not shown). Components and techniques herein are described with reference to HDPE and SRPE pipes, for example.

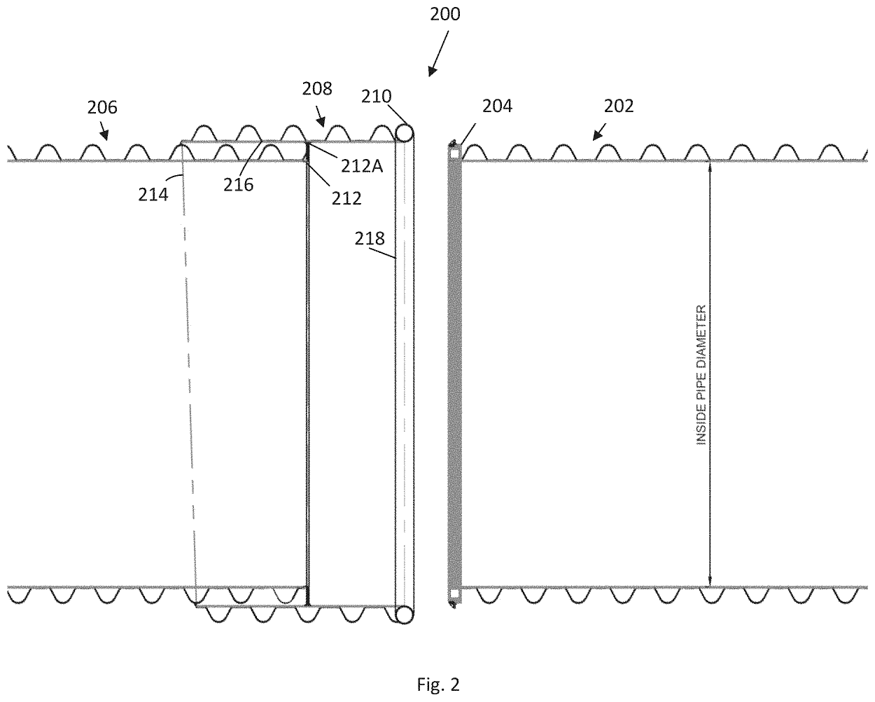

FIG. 2 is a cross-sectional profile of a pre-end to end connection 200 of a first pipe 202 (e.g. a connecting pipe) with a gasket seat spigot ring 204 and a second pipe 206 (e.g. a mainline pipe) with a bell 208. Bell 208 is fabricated from a short length of larger diameter SRPE pipe with a same wall profile as the mainline pipe 206 and connecting pipe 202 as described further herein.

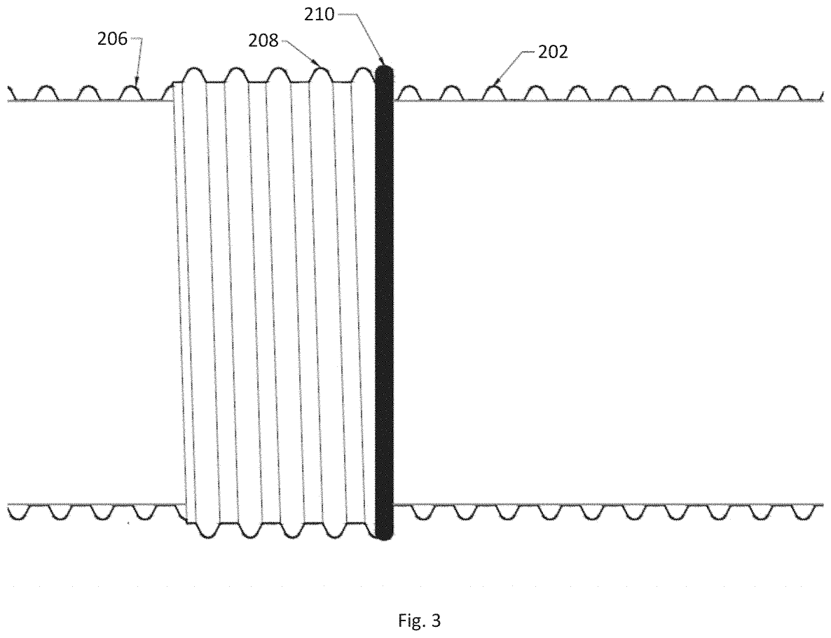

Bell 208 comprises a bell lip 210 (an annular component). A bell stop 212 (an annular component) is provided on mainline pipe 206 inside bell 208. The bell stop 212 may be rectangular to form a flat flange, such as at an outer surface 212A that engages bell 208, for example, for assistance with welding thereto. Bell 208 works as an external sleeve, sliding over the outside diameter of the mainline pipe 206 during construction where it is welded to the outer surface of mainline pipe 206. Given a similar wall profile, ribs of bell 208 are positioned between ribs of mainline pipe 206 to facilitate welding. Bell 208 extends over the mainline pipe 206 from a bell end 214 to the bell stop 212 that encircles an open end 218 of the bell 208 by approximately a length equal to 2 times the pitch of the (omega shaped) reinforcing rib. This overlapping end of the bell (i.e. along bell liner 216 between bell stop 212 and bell end 214) is welded to the mainline pipe 206 along the outside top edges of its rib to the inside surface of the pipe liner of the bell 208 at its physical end. Secondly the overlapping end is welded to the bell stop 212. The portion of the bell's length extending beyond the mainline pipe (between stop 212 and lip 210) is the insertion depth for the adjoining connecting pipe 202 fitted with the composite gasket seat spigot ring 204. FIG. 3 shows an end-to-end connection with connecting pipe 202 and mainline pipe 206 cut away in profile and bell 208 shown not cut away. Connecting pipe 202 is seated in bell 208 of the mainline pipe 206.

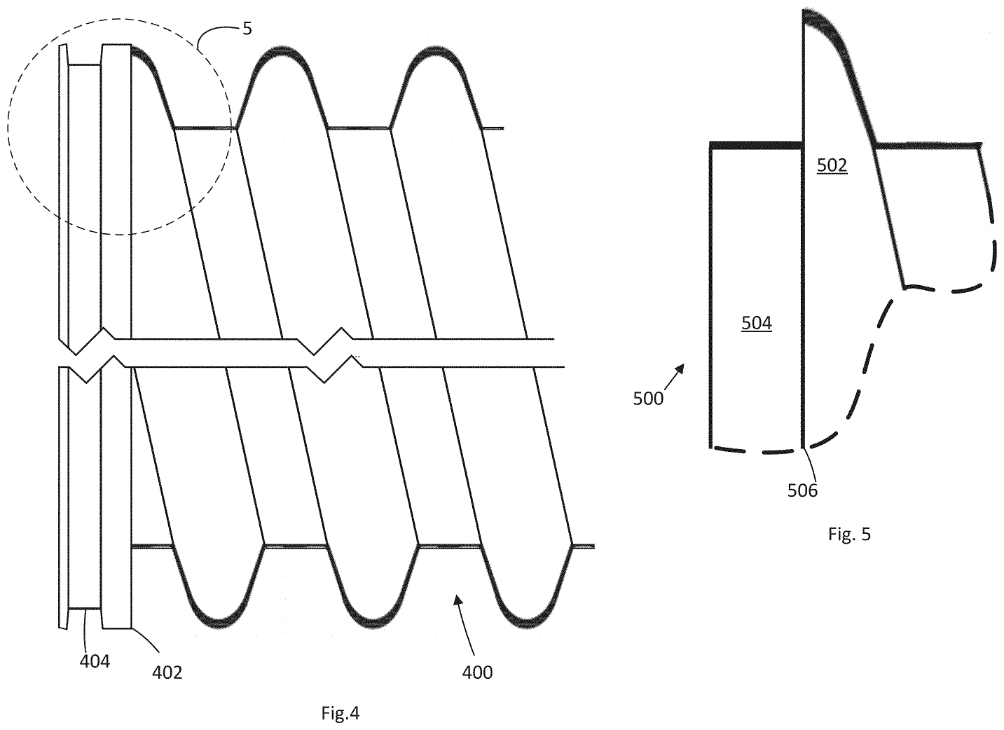

FIG. 4 is an enlarged view of a connecting pipe 400 showing a profile of a spigot ring 402 in more detail. FIG. 5 is a further enlarged view of a portion (generally indicated by large arrow 5) of an end 500 of second pipe 400 of FIG. 4 without spigot ring 402. End 500 comprises a portion of a rib 502 and a portion of pipe liner 504. As described further, rib 502 is cut to expose pipe liner 504 to define a sufficiently sized band of pipe liner to receive spigot ring 402. Spigot ring 402 and pipe liner 504 may be welded together as described further below. Given the helical nature of the ribs on a SRPE pipe, only some of rib 502 adjacent the pipe end, such as along line 506, requires removal. When cut away, the interior of the rib is at least partially open, requiring closure.

Spigot rings (e.g. 204 or 402) may perform a number of functions. They maintain pipe roundness at an end of the connecting pipe, providing an annular groove for seating the gasket. They reinforce the pipe end, as the integrity of the steel rib has been compromised, as shown in FIG. 5, due to the helical angle of the rib relative to the square end of the pipe. They provide a seat 404 for a sealing gasket (e.g. of rubber) and function as a structural member to resist the seating pressures the gasket imparts to the pipe end when the completed joint is subject to specified pressure limits (internal hydrostatic pressure or vacuum) as dictated by the relevant (CSA or ASTM) standards and/or specified joint performance criteria. Spigot rings also contribute to the resistance the pipe wall is required to provide to support overburden (soil) pressures. Thus a spigot ring is key component in a bell and gasket spigot connection for flexible pipe joints.

Given the role of a spigot ring to provide support for a sealing gasket, it may also be termed a gasket seat.

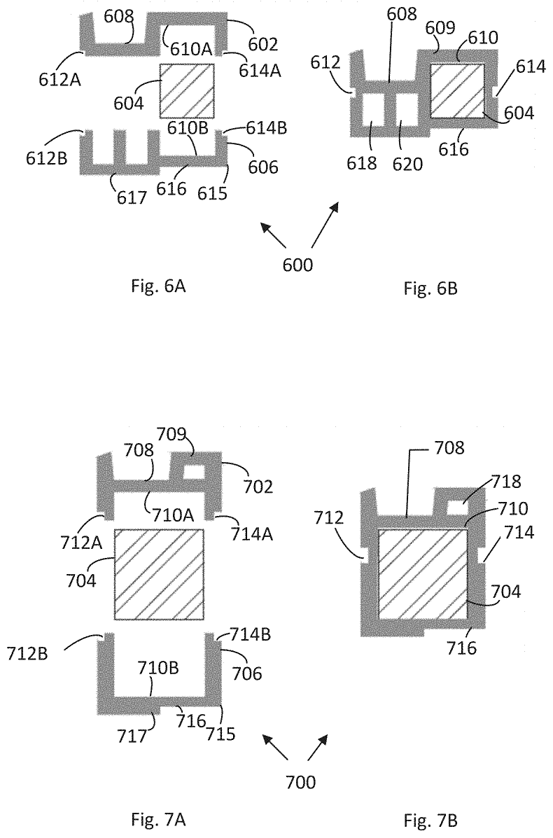

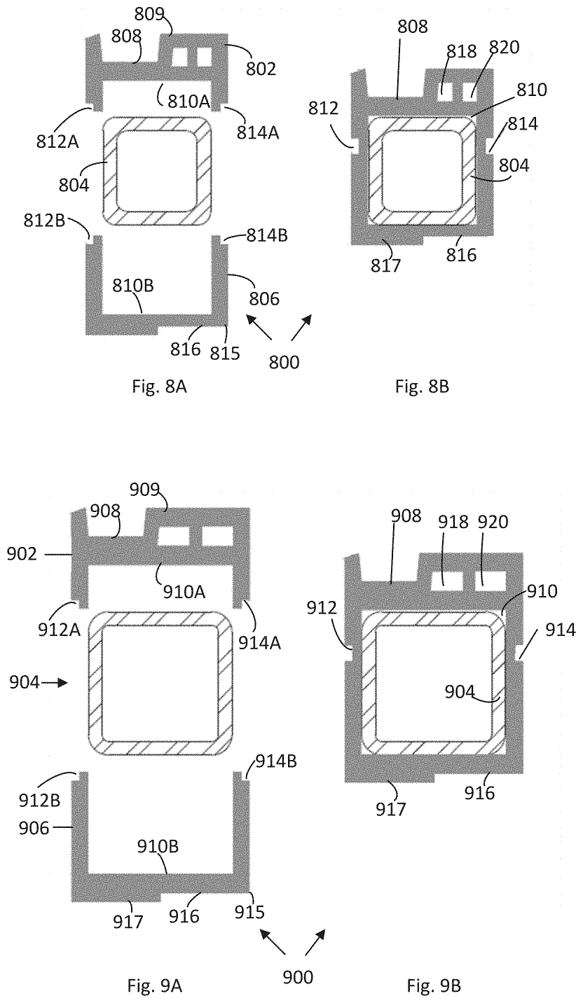

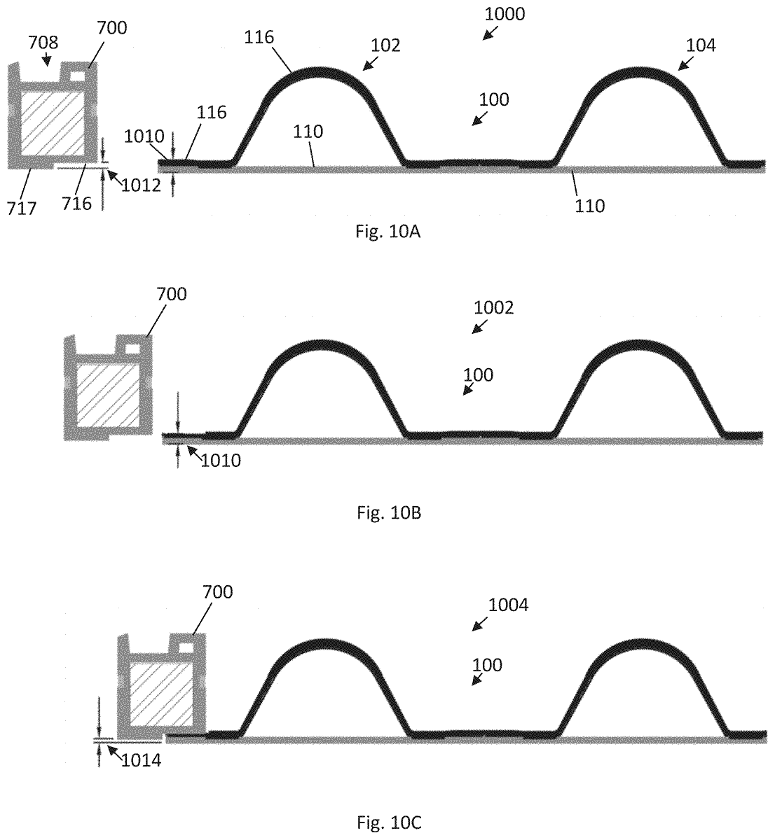

FIGS. 6A-6B, 7A-7B, 8A-8B, and 9A-9B show respective cross-sectional views, in exploded and assembled forms, of example gasket seat spigot rings 600, 700, 800 and 900. All of these rings 600, 700, 800 and 900 will be described together.

In some applications a gasket seat spigot ring (e.g. 600, 700, 800 and 900) comprises:
i) two extruded High Density Polyethylene (HDPE) profiles (e.g. upper sleeve 602, 702, 802 and 902 and lower sleeve 606, 706, 806 and 906) that, when welded together, form the external frame of the spigot ring and form a ring cavity 610, 710, 810 and 910; and
ii) a metal ring 604, 704, 804 and 904.

The metal ring 604, 704, 804 and 904 may have a square or rectangular cross section as shown or a circular cross section (not shown) and be either solid or hollow in construction. They may comprise aluminum or other metals (alloyed or not). Alternative metal profiles may also be used to fabricate the metal ring.

Each of the sleeves and ring may be formed by applicable methods, cut to a desired length, and curled (e.g. by rolling etc.) end to end for forming a receptive annular body of a desired diameter to mate with a pipe having a respective outer pipe liner diameter. It is understood that aluminum rings may be extruded but some types of metal rings may be formed in other manners as is well known.

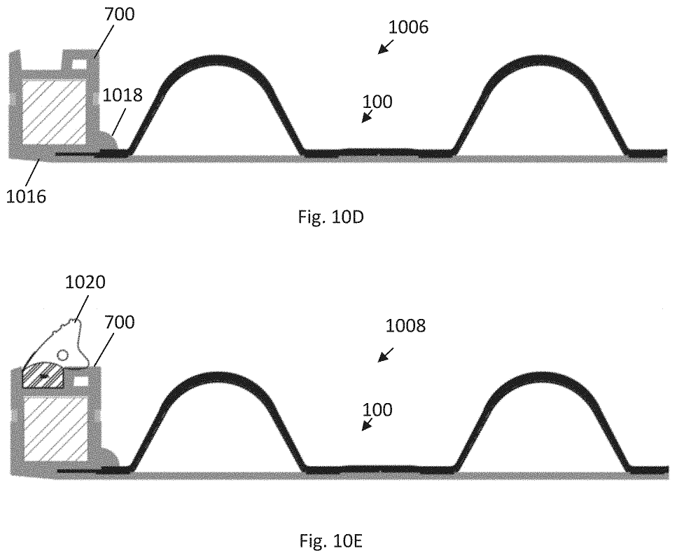

The upper sleeve 602, 702, 802 and 902 defines an annular groove 608, 708, 808 and 908 on a respective exterior surface 609, 709, 809 and 909 to “seat the gasket” (See FIG. 10E for a gasket in a seat). The groove is annular when the sleeve is formed into the spigot, that is, when the upper and lower sleeves are welded to each other with the metal ring in the ring cavity defined between the sleeves. Opposite ends of the upper sleeve are welded to each other as are opposite ends of the lower sleeve to define the spigot ring.

Assembled gasket seat spigot rings 600, 700, 800 and 900 of FIGS. 6B, 7B, 8B and 9B are configured for different sized pipes. The height of the HDPE profile (the upper sleeve 602, 702, 802 and 902 and lower sleeve 606, 706, 806 and 906 when welded together) is mainly governed by the height of the pipe ribs (e.g. 502). The width of the HDPE profile is governed by the width of the gasket itself and the size of the metal ring 604, 704, 804 and 904 inside it. By way of example and without limitation, gasket seat spigot ring 600 is 31 mm high×52 mm wide, gasket seat spigot ring 700 is 53 mm×44 mm, gasket seat spigot ring 800 is 62 mm×50 mm and gasket seat spigot ring 900 is 81 mm by 63 mm. Height is measured orthogonally to a longitudinal axis or pipe center and width is parallel to the longitudinal axis, along the pipe's exterior surface.

Each metal ring 604, 704, 804 and 904 provides substantial rigidity and support to the respective gasket seat spigot ring 600, 700, 800 and 900, particularly in the direction orthogonal to the longitudinal axis of a pipe when fitted thereon. The metal rings as shown all have a height that is a substantial proportion of a width, for example, in contrast to a band which has a width substantially larger than a height. The height is at least 50% of the width and in the illustrated examples is equal to the width. In examples 700, 800 and 900, respective rings 704, 804 and 904, support respective annular grooves 708, 808 and 908 such that a gasket is seated between the ring and an inner surface of the bell when mounted. In an SRPE pipe, the height of the metal ring is 50% or more of the height of the projection of the steel reinforcement.

Each ring cavity 604, 704, 804 and 904 may be defined by a respective upper channel 610A, 710A, 810A and 910A of the upper sleeves 602, 702, 802 and 902 and lower channel 610B, 710B, 810B and 910B of the lower sleeves 606, 706, 806 and 906. At exterior margins of the upper and lower sleeves each may define a respective pair of upper weld seats and lower weld seats where upper weld seats 612A, 614A, 712A, 714A, 812A, 814A, 912A and 914A pair respectively with lower weld seats 612B, 614B, 712B, 714B, 812B, 814B, 912B and 914B to define weld seats 612, 614, 712, 714, 812, 814, 912 and 914 when the respective sleeves are assembled with respective rings. The upper sleeves are welded to the respective lower sleeves using the respective weld seats to receive welding material.

Each lower sleeve 606, 706, 806 and 906 may define a stepped pipe receiving surface 616, 716, 816 and 916. This surface is located along a pipe facing edge 615, 715, 815 and 915 of an exterior surface 617, 717, 817 and 917 opposite the upper sleeve 602, 702, 802 and 902 to receive a prepared pipe end surface for welding thereto as shown further in FIGS. 10A-10E. Structural rigidity may be provided to respective annular grooves 608, 708, 808 and 908, via walled cavities (e.g. 618, 620, 718, 818, 820, 918, and 920) defined within one of the sleeves or both such as by the assembly of the sleeves or otherwise.

FIGS. 10A-10E show an assembly procedure in steps 1000, 1002, 1004, 1006 and 1008 to mount and weld a gasket seat spigot ring 700 according to FIG. 7B to an end of an SPRE pipe 100 of FIG. 1, in accordance with an example. Other gasket seat spigot rings may be similarly mounted and welded.

At step 1000, spigot ring 700 is provided with a pipe 100 for assembly. Pipe 100 is prepared, for example, as per FIG. 5 to remove a portion of the end rib adjacent the pipe end. Pipe liner wall 110 and top layer of HDPE 116 may have a variable thickness at pipe end 1010 (e.g. between the opposing arrows). The thickness is typically more than 5 mm. As noted previously, stepped surface 716 is offset about 3 mm (e.g. at 1012) from exterior surface 717 of spigot ring 700.

At step 1002, top layer of HDPE 116 and/or pipe liner wall 110 is machined to 5 mm thickness for all pipe sizes. At step 1004, gasket seat spigot ring 700 is slid over the pipe end 1010. Gasket seat spigot ring 700 has a 3 mm stepped surface 716 giving a 2 mm raised profile or step (indicated at 1014) between the bottom of the spigot 700 and the inside diameter of the pipe 100 at the pipe end 1010.

At step 1006, the two HDPE components 700 and 100 are welded in two positions 1016 and 1018, respectively at the leading edge of end 1010 (inside diameter) of the pipe and at the exterior surface of the pipe. A continuous weld is performed around the pipe periphery inside and outside where the spigot ring 700 meets the pipe end 1010. At step 1008, a gasket 1020, comprising a rubber ring, is seated in annular groove 708. The dimensions provided are representative and may vary.

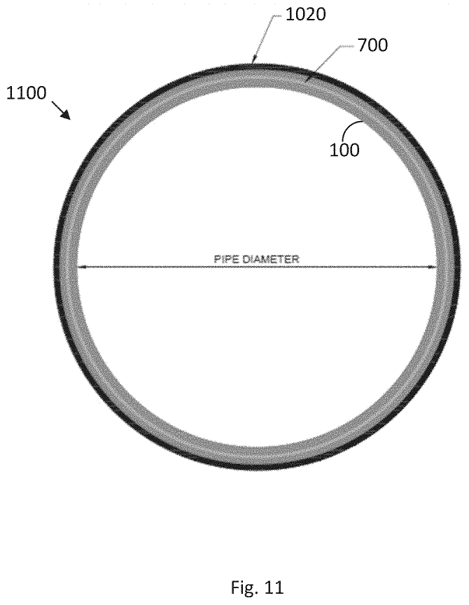

FIG. 11 shows an end elevation 1100 of a mounted spigot 700 with a gasket 1020 on SPRE pipe 100.

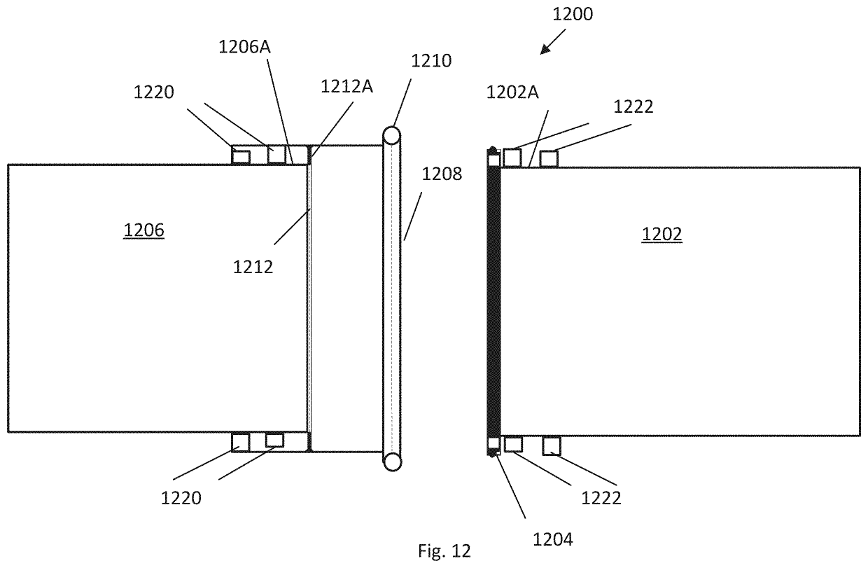

FIG. 12, similar to FIG. 2, is a profile of a pre-end to end joint 1200 of a first or connecting pipe 1202 having a gasket seat spigot 1204 and a second or mainline pipe 1206 having a bell 1208, in accordance with an example, where the mainline pipe 1206 and connecting pipe 1202 comprise smooth inner surfaces (e.g. from a pipe liner having a top layer on the pipe liner). In contrast to FIG. 2, mainline pipe 1206 and connecting pipe 1202 also comprise smooth outer surfaces 1206A and 1202A, at least adjacent at the respective joining ends for coupling via the bell 1208. The connecting pipe 1202 and mainline pipe 1204 and bell 1206 may each be constructed of HDPE pipe or in the case of a bell 1206 a pipe segment.

Bell 1208 comprises a lip 1210. A bell stop 1212 is provided on mainline pipe 1206 inside bell 208. The bell stop 1212 may be rectangular to form a flat flange, such as at an outer surface 1212A that engages bell 1208, for example, for assistance with welding thereto. Bell 1208 works as an external sleeve, sliding over the outside diameter of the mainline pipe 1206 during construction where it is welded to the outer surface of mainline pipe 1206. In the present example, a plurality of spacer blocks 1220, are welded to the outer surface of mainline pipe 1206 annularly spaced about the end adjacent the bell stop. A plurality of spacer blocks 1222 are welded to the outer surface of connecting pipe 1202, annularly spaced about the end adjacent the gasket seat spigot. Such may be welded before the spigot is fitted.

The bell 1208 is welded to the respective exterior surfaces of the mainline pipe 1206 and connecting pipe 1202 (having a gasket seat spigot ring fitted thereto) via the respective spacer blocks 1220 and 1222. In another example, not shown, the blocks may be a wedge shape with respective leading edges to facilitate connection of the bell over the mainline pipe 1206 by sliding and by connection of the connecting pipe 1202 by sliding into the bell 1208.

The height of the metal ring in the spigot is at least 50% of the height of the spacer blocks.

Thus to manufacture a mainline HDPE pipe with a bell, a method may be performed to weld to an outer surface of the mainline HDPE pipe a plurality of spacer blocks annularly spaced adjacent a pipe end to receive the bell. A length of a second HDPE pipe having a same construction as the mainline HDPE pipe to define the bell is provided where the second HDPE pipe having an interior diameter sufficiently larger than an outer diameter of the mainline HDPE pipe and the plurality of spacer blocks for attachment. The mainline HDPE pipe and second HDPE pipe are relatively slided such that the mainline HDPE pipe with the plurality of spacer blocks is partially inserted into the second HDPE pipe defining the bell.

The second HDPE pipe and the plurality of spacer blocks of the mainline HDPE pipe are welded together.

The mainline HDPE pipe comprises an annular bell stop at an end of the mainline HDPE pipe. The welding may weld the second HDPE pipe to a top of the bell stop and where the top defines a flange.

In another example, not shown, the inner diameter of the bell that fits over the mainline pipe 1206 is only slightly larger than the outer diameter of the mainline pipe 1206 such that the pipe segment of the bell and the mainline pipe may be welding together directly. The bell may have a flared end to receive the connecting pipe with a gasket seat spigot ring fitted thereto.

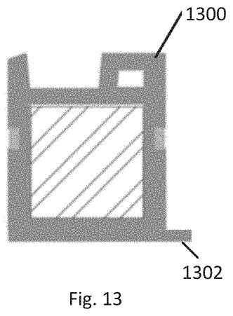

In an example, the gasket seat spigot ring may be mounted to a connecting pipe in a different manner such as by butt welding. The connecting pipe's outer and/or inner liner may not be machined to mount the gasket seat spigot ring. The gasket seat spigot ring need not have a stepped surface (e.g. 616, 716, 816 and 916) to receive the machined pipe end. A gasket seat spigot ring may have an extension member to weld to a connecting pipe such as at an inner liner thereof (not shown). FIG. 13 shows a gasket seat spigot ring 1300 similar to 700 but comprising an extension member 1302 in place of stepped surface 716.

Extruding a linear HDPE profile to the physical dimensions required for a spigot ring presents a variety of manufacturing challenges due in part to the high temperatures required to liquefy HDPE. A second challenge is to convert a linear HDPE profile of a significant mass into a circular ring and maintain required size tolerances. The proposed two part sleeve can be extruded more readily as the mass of HDPE required is greatly reduced. The sleeve profiles are designed to minimize profile distortion when subject to the strains encountered when rolling the profile to required pipe radii.

Encasing a metal ring in a two part (upper and lower) HDPE sleeve ensures roundness of the spigot ring. The composite spigot ring provides a structural advantage not available in a homogenous spigot ring extruded solely from HDPE. The metal ring provides the assembly with sufficient stiffness matching the stiffness of neighboring ribs and sufficient to resist loads.

The unique design of the HDPE profile, as a whole, has some advantages from manufacturing standpoint. The small weld seat between the upper and lower sleeves is easy to fill with weld to ensure full bond between the two sleeves. In addition, the step on the bottom of the profile provides a “home place” for the prepared pipe liner. Welding the pipe liner to the spigot at this step ensures full bond between the pipe and the spigot (as opposed to butt welding the spigot to the liner)

The composite design of the spigot ring offers a more robust end treatment for a flexible pipe. This makes the pipe end less prone to handling and shipping damages. It also enhances the pipe end to resist the forces incurred when inserting the spigot carrying a gasket into the adjoining pipe bell when laying successive pipe lengths in the trench.

What is claimed is:

1. A gasket seat spigot ring comprising:
an upper sleeve defining an annular groove on an exterior surface of the upper sleeve to provide a gasket seat;
a lower sleeve welded to the upper sleeve; and
a metal ring; and
wherein the metal ring is received in a ring cavity defined between the upper sleeve and the lower sleeve.

2. The gasket seat spigot ring of claim 1, wherein the metal ring comprises a height which is at least 50% of a width of the metal ring.

3. The gasket seat spigot ring of claim 2, wherein the height of the metal ring is at least 50% of a height of a rib projecting from a reinforced pipe when the spigot ring is attached to the pipe.

4. The gasket seat spigot ring of claim 1, wherein the upper sleeve and lower sleeve each define an annular shape with opposite ends of the upper sleeve welded together and opposite ends of the lower sleeve welded together.

5. The gasket seat spigot ring of claim 1, wherein the lower sleeve defines a stepped pipe receiving surface at a pipe facing edge of an exterior surface of the lower sleeve, opposite the upper sleeve, to receive a pipe surface for welding thereto.

6. The gasket seat spigot ring of claim 1 configured to extend substantially equivalent to a height of a rib projecting from a reinforced pipe when the spigot ring is attached to the pipe.

7. The gasket seat spigot ring of claim 1, wherein each of the upper sleeve and lower sleeve have respective mating surfaces about their respective peripheries, the mating surfaces each defining weld seats to weld the upper sleeve and lower sleeve to one another.

8. The gasket seat spigot ring of claim 1, wherein the upper sleeve and lower sleeve comprise high density polyethylene (HDPE) material formed to define annular shapes.

9. The gasket seat spigot ring of claim 1, wherein the metal ring is aluminum or other metal formed to define an annular shape for fitting in the upper sleeve and lower sleeve.

10. The gasket seat spigot ring of claim 1, comprising one or more walled cavities to provide integrity to the annular groove.

11. A mainline pipe and a gasket seat spigot ring assembly wherein the gasket seat spigot ring is fitted to a pipe end of the mainline pipe and comprises:
an upper sleeve defining an annular groove on an exterior surface of the upper sleeve to provide a gasket seat;
a lower sleeve welded to the upper sleeve; and
a metal ring, the metal ring received in a ring cavity defined between the upper sleeve and the lower sleeve.

12. A method of manufacturing a gasket seat spigot ring comprising:
extruding an upper sleeve having a groove to receive a gasket seat on an exterior surface of the upper sleeve;
extruding a lower sleeve, the upper sleeve and lower sleeve defining a ring cavity to receive a metal ring;
forming the metal ring;
rolling the upper sleeve, lower sleeve and metal rings to define annular shapes;
placing the metal ring in the ring cavity between the upper sleeve and lower sleeve; and
welding the upper sleeve and lower sleeve together.

13. A method of fitting a gasket seat spigot ring to an end of a first pipe for connecting to a second pipe via a bell, the method comprising:
preparing an exterior surface of an end of the first pipe to receive the spigot ring;
guiding the spigot ring partially over the exterior surface of the end of the first pipe; and
welding the spigot ring to the end of the first pipe.

14. The method of claim 13, wherein the spigot ring comprises:
an upper sleeve defining an annular groove on an exterior surface of the upper sleeve to provide a gasket seat;
a lower sleeve welded to the upper sleeve; and
a metal ring, the metal ring received in a ring cavity defined between the upper sleeve and the lower sleeve.

15. The method of claim 13, wherein the lower sleeve defines a stepped pipe receiving surface at a pipe facing edge of an exterior surface of the lower sleeve opposite the upper sleeve to receive the exterior surface of the end of the first pipe for welding thereto.

16. The method of claim 13, wherein the spigot ring receives the exterior surface of the end of the first pipe to define a step between a bottom of the spigot ring and an inside diameter of a pipe liner of the first pipe for welding.

17. The method of claim 16, wherein a continuous weld is performed around a pipe periphery, inside and outside, where the spigot ring meets the end of the first pipe.

18. The method of claim 13, wherein the first pipe is an SRPE pipe and wherein preparing comprises removing a portion of a rib of the SRPE pipe.

19. The method of claim 13, wherein the first pipe is an SRPE pipe and wherein preparing comprises machining the SRPE pipe to produce a uniform pipe end thickness for welding.
